(19) United States
(12) Patent Application Publication
(10) Pub. No.: US 2006/0086446 A1
(43) Pub. Date: Apr. 27, 2006

(54) Device intended to lock the beads of a tire cover against the flanges of a rim

(76) Inventors: Florence Ratet, Chalette Sur Loing (FR); Gerard Tavin, Angers (FR); Michael Finsterbusch, Langhorne, PA (US)

Correspondence Address: CLARK & BRODY, 1090 VERMONT AVENUE, NW, SUITE 250, WASHINGTON, DC, 20005, US

(21) Appl. No.: 11/256,074

(22) Filed: Oct. 24, 2005

(30) Foreign Application Priority Data
Oct. 25, 2004 (FR) 0411338

(51) Int. Cl. B60C 5/16

(52) U.S. Cl. 152/400

(57) ABSTRACT

Locking device for locking the beads of a tire cover against the flanges of a wheel rim onto which said cover is fitted, said device comprising an annular structure attached around said rim, characterized in that said structure is lightened so that its weight is less than 10 kg and in that it includes, at least locally, means for stiffening it so as to increase its mechanical resistance to compressive forces exerted by said beads against said structure.

### FIELD OF THE INVENTION

The present invention relates to a device designed to lock the beads of a tire cover against the flanges of a wheel rim onto which said cover is fitted, this locking device being able to be used in particular for equipping a motorized vehicle designed to be driven over loose or rough ground and/or with reduced inflation pressures, such as a military or civil vehicle.

### BACKGROUND OF THE INVENTION

United States patent document U.S. Pat. No. 5,271,443 discloses a locking device of the “beadlock” type which includes a sheet metal ring of “U” cross section onto the lateral edges of which annular rubber flange-pieces are riveted, which flange-pieces are themselves fitted into the rim well and are designed to exert an axial compressive force on the beads of the cover so as to press each of the beads against the rim flange designed to grip it.

However, a major drawback of this type of locking device lies in the relatively large thickness of the metal sheet used for the ring, typically around one tenth of an inch (i.e. more than 2.5 mm) which is required to give the lateral edges of this ring forming the branches of the “U” sufficient resistance to the compressive and shear forces exerted by the beads of the cover on these edges when the vehicle is being driven.

It follows that this use of the ring made of a relatively thick metal sheet results in the locking device incorporating this ring being relatively heavy, typically with a weight of the order of 10 kg, which has the effect of making the fitted assemblies provided with these locking devices heavier, and consequently also the vehicles equipped with these fitted assemblies. In particular, this overall increase in weight increases the cost of airlifting the vehicles, such as armored military vehicles.

### BRIEF SUMMARY OF THE INVENTION

It is an object of the present invention to provide a device for locking the beads of a tire cover against the flanges of a wheel rim onto which the cover is fitted, which remedies the aforementioned drawbacks by having in particular a reduced weight in comparison with the aforementioned weight of the known devices, while still ensuring that the beads are satisfactorily jammed against the flanges of said rim, this device comprising an annular structure of a weight less than 10 kg which is attached around said rim, said structure comprising a cylindrical ring and, at least locally, means for stiffening it so as to increase its mechanical resistance to compressive forces exerted by said beads against said structure.

For this purpose, the lateral edges of the ring that extend on either side of its cylindrical surface, in a first case, receive linking means made of an elastic material that are intended to come into contact with the beads of the cover or, in a second case, have bearing surfaces designed to bear on said beads via elastic means in the form of circumference corrugations in said ring.

Advantageously, said structure has a weight of 7 kg or less.

According to one embodiment of the invention relating to said first case, said structure comprises a split ring having a thickness of material of 8 mm or less, this thickness possibly being 2 mm or less in the case of a sheet metal ring and being for example 6 mm in the case of a plastic ring.

According to an advantageous example of the invention relating to said first case, each lateral edge of the ring then has a cross section in the form of a “T”. Preferably, said ring then includes a central part between said lateral edges that is extended approximately at right angles by a portion that is folded back on itself to form a fold constituting the top of said “T”. It will be noted that this fold may be formed on one side of the top of the “T” or on the other.

According to another feature of this first case according to the invention, said linking means then comprise two annular flange-pieces made of rubber that are mounted on said lateral edges, respectively, and advantageously the locking device contains no means for fastening said flange-pieces to said ring.

According to an advantageous feature of the invention relating to said first case, said ring comprises:

either a plurality of ribs formed along generatrices of the ring, said ribs being designed to stiffen said device with regard to forces exerted thereon in its width direction, said ring then being advantageously apertured between said lateral edges;

or a plurality of openings over its circumference and between said lateral edges, the wall of at least one or each of said openings forming a rib on at least one face of said ring.

According to another advantageous feature of the aforementioned embodiment of the invention, said ring is based on a metal sheet or on at least one thermoplastic polymer.

According to an alternative embodiment of the invention relating to said first case, each of said ribs has a prismatic or cylindrical geometry for example with a total height of 15 mm, linking means designed to come into contact with the beads of the cover including a plurality of plugs that close off the hollow bases of at least several of said ribs. It will be noted that several or all of these plugs could be joined together on each side of said ring.

According to another feature of this alternative embodiment according to the invention, the locking device contains no means for fastening said plugs to said ring.

According to another feature of this alternative embodiment according to the invention, said ring is based on at least one thermoplastic polymer or else based on at least one metal.

According to another alternative embodiment of the invention relating to said first case, said annular structure comprises, along its generatrices, a plurality of cylindrical or prismatic tubes that are connected together pairwise via at least one joining element, such as a flexible link or a catching element, and are designed to stiffen said device with regard to forces exerted thereon in its width direction, in such a way that said annular structure is of the composite type.

It will be noted that these circumferentially juxtaposed tubes may be made of metal or of plastic, and that they each have, for example, a height of 15 mm.

According to another alternative embodiment of the invention relating to said second case, where the locking device comprises a ring in which said elastic means are formed for directly clamping the lateral edges of said ring directly against said beads, each lateral edge has then a crown-shaped bearing surface designed to bear on one of said beads.

According to another feature of said second case according to the invention, the locking device consists of said ring, which is closed.

According to another advantageous feature of the invention relating to an annular structure specifically comprising a split ring, at least one of the two ends of this ring terminates in at least one tab intended to secure said ends one with respect to the other.

It will be noted that said or each securing tab (i.e. for closing the split ring) has in this case a structure integral with the ring, unlike attached fastening means such as linking bars provided with bolts, thereby locally stiffening the ring closure region which, as is known, constitutes a region of weakness of the annular structure, and also limiting the number of components attached to this structure.

Advantageously, the width of said or each securing tab is less than that of said ring, the other or each end terminating in at least one bent-up radial projection that is designed to stiffen said ring in its width direction.

According to one exemplary embodiment of the invention, one of said ends terminates in said securing tab and the other end terminates in a pair of said radially bent-up projections.

According to an alternative embodiment of the invention, one of said ends terminates in said securing tab and the other end terminates in a single radially bent-up projection which is thus continuous over the width of said ring.

According to another feature of the invention, said securing tab is designed to be fastened to said other end that it covers by any mechanical fastening means or else by adhesive bonding.

According to another alternative embodiment of the invention, it will be noted that the split ring may include, in combination, on the one hand, said linking bar attached to said ends in order to secure them one with respect to the other and, on the other hand, at least one of said bent-up radial projections extending substantially over the entire width of the corresponding end of the ring in order to stiffen said ring in its width direction.

A fitted assembly according to the invention can be used to equip a motorized vehicle designed to be driven over loose or rough ground and/or with reduced inflation pressures, such as an armored military vehicle or a civil vehicle of the “off-road” type, said fitted assembly comprising a wheel rim, which terminates axially on the outside in two flanges, and a tire cover having beads mounted against said flanges, respectively, via a locking device designed to jam said beads against said flanges and which is as defined above.

A motorized vehicle according to the invention can be used for being driven on loose or rough ground and/or with reduced inflation pressures, such as an armored military vehicle or a civil vehicle of the “off-road” type, and it is provided with fitted assemblies according to the invention.

### BRIEF DESCRIPTION OF THE DRAWINGS

Other features, advantages and details of the present invention will become apparent on reading the following description of several exemplary embodiments of the invention, given by way of illustration but implying no limitation, said description being with reference to the appended drawings in which:

FIG. 1 is a meridional sectional view of a known fitted assembly comprising a multi-piece wheel rim, a tire cover fitted onto said rim and a known locking device;

FIG. 2 is a detailed cross-sectional view of one of the two lateral edges of the locking device of FIG. 1;

FIG. 3 is a partial circumferential sectional view illustrating the known means for assembling the two ends of a split device according to FIG. 1;

FIG. 4 is a partial perspective view of a locking device according to a first exemplary embodiment of the invention;

FIG. 5 is a partial perspective view of a locking device according to a variant of this first exemplary embodiment of the invention;

FIG. 6 is a partial view, in section along a directrix, of a locking device according to another variant of this first exemplary embodiment of the invention;

FIG. 7 is a partial view, in section along a directrix, of a locking device according to another variant of this first exemplary embodiment of the invention;

FIG. 8 is a cross-sectional view of one of the two lateral edges of the devices shown in FIG. 6 or 7;

FIG. 9 is a partial cross-sectional view of one of the two lateral edges of a locking device according to another exemplary embodiment of the invention;

FIG. 10 is a cross-sectional view of a locking device according to another exemplary embodiment of the invention, which is shown inside a fitted assembly seen in meridional section; and

FIG. 11 is a perspective see-through partial view of the two ends of a split ring that are included in a locking device according to the invention, these ends being secured one with respect to the other.

### DETAILED DESCRIPTION OF THE INVENTION

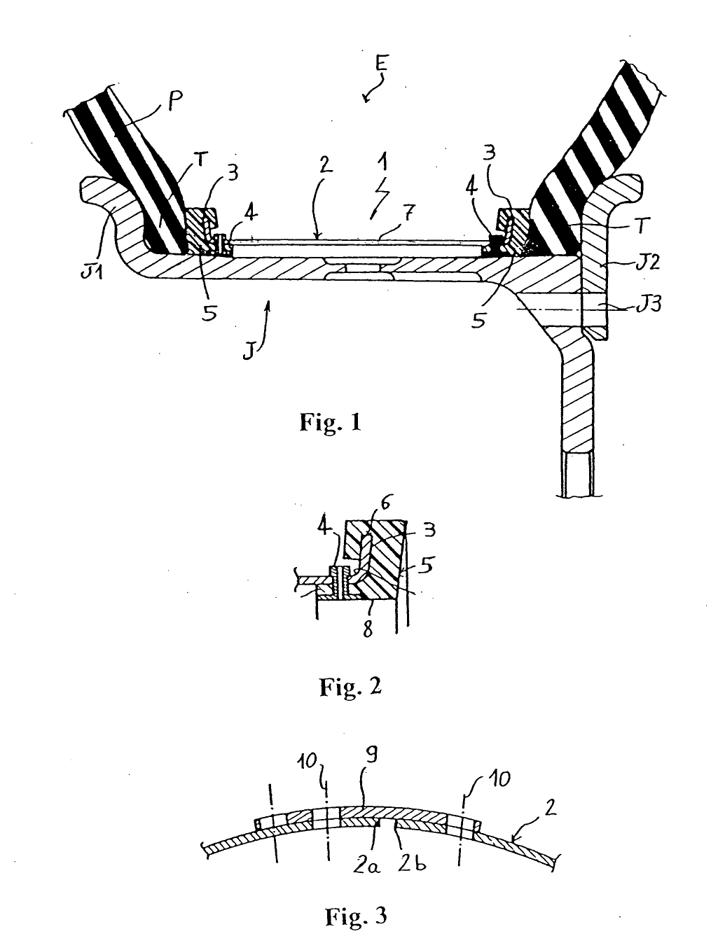

The fitted assembly E shown in FIG. 1 corresponds to the prior art mentioned in the preamble, and it comprises a wheel rim J of a multi-piece type with a flat well, a tire cover P fitted against the flanges J1, J2 of the rim J and a locking device 1 for locking the beads T of the cover E against these flanges J1, J2. The locking device 1 is formed by an annular structure comprising a sheet metal ring 2 of “U” cross section, to the lateral edges 3 of which annular rubber flange-pieces 5 are fastened by rivets 4, which flange-pieces themselves are fitted into the well of the rim J and are designed to jam the beads T against the flanges J1, J2.

To fit the locking device 1 inside the cover P, the ring 2 is split and its two end parts 2a and 2b are then secured one with respect to the other by at least one linking bar 9 that covers them and are fastened by bolts or the like mounted in holes 10 drilled in the bar 9 and the end parts 2a and 2b, as illustrated in FIG. 3.

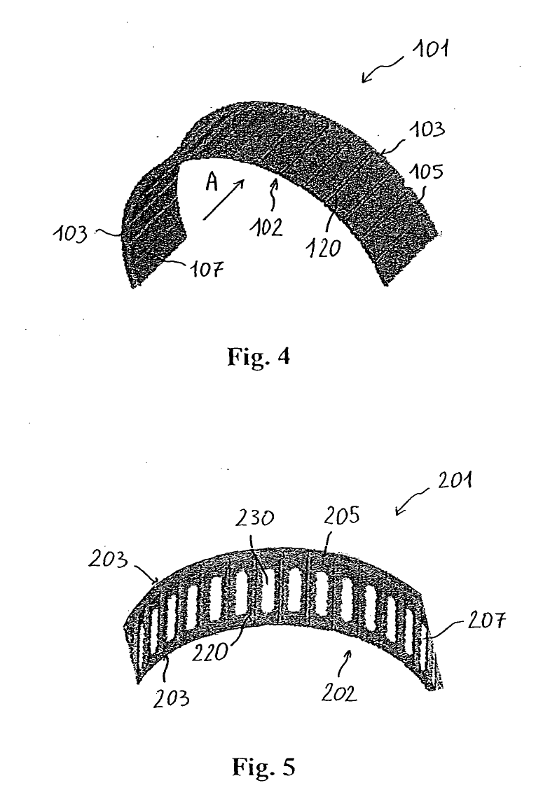

A locking device 101 according to the invention is illustrated in FIG. 4 in a partial perspective view, and it also comprises a split metal ring 102 of “U” cross section, similar to the ring 2 of FIG. 1, but with a smaller thickness of the order of 1 mm and a plurality of ribs 120 that are uniformly distributed around its circumference and are designed to stiffen the ring 102 in anticipation of stresses exerted by the beads T, these stresses being depicted by the arrow A.

The ribs 120 extend parallel to the generatrices of the ring 102 and are formed (for example machined or stamped) on the external face of the ring 102. Annular flange-pieces 5 of the type of those in FIG. 1 are fitted onto and fastened to the lateral edges 103 of the ring 102. However, the mass of this locking device 101 can be reduced to around 7 kg for example.

The locking device 201 illustrated in FIG. 5 is a variant of that illustrated in FIG. 4, which allows its weight to be reduced to 5 kg for example, by providing openings 230 in the ring 202 in order to lighten it. These openings 230 may have any shape and may be uniformly distributed around the ring 202.

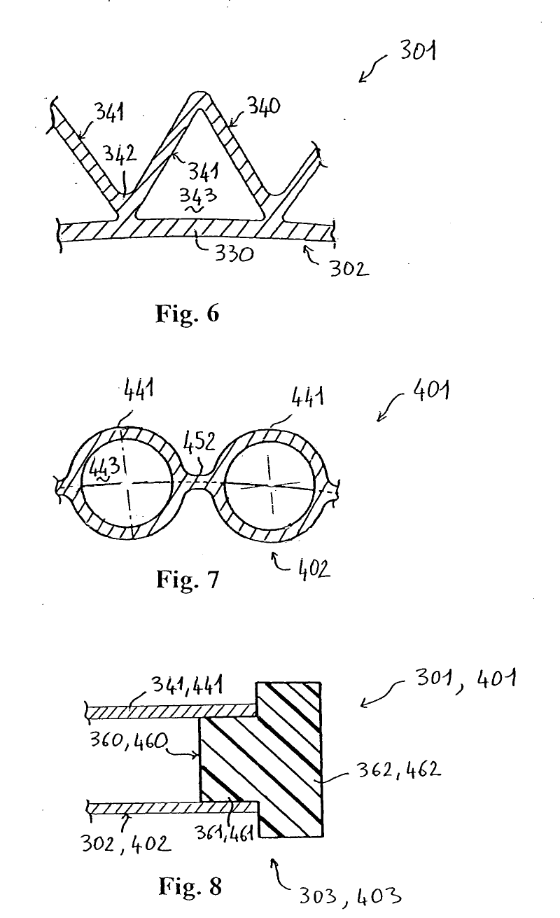

The locking device 301 illustrated in FIG. 6 is a closed or split ring 302 and for example made of plastic. This ring 302 is formed from a cylindrical internal wall 330, intended to be fitted into the well of the rim J, and from an external wall 340 consisting of a plurality of hollow stiffening right prisms 341 parallel to the generatrices of the wall 330, said prisms being uniformly distributed around the circumference of the ring 302 and joined together pairwise by a common edge 342, so as to form a chain.

The locking device 401 of FIG. 7 is an alternative embodiment of that illustrated in FIG. 6, the ring 402 being a closed or split plastic ring. The ring 402 is formed from a plurality of hollow right cylinders 441 parallel to the generatrices of the ring 402, which cylinders are uniformly distributed around its circumference and are connected together pairwise by a linking portion 452, so as to form a chain. Each cylinder 441 is bounded by two empty bases 443 forming the lateral edges 403 of the ring 402, which bases are for example circular in shape. The ring 402 is designed to be fitted into the well of the rim J so that each of the cylinders 441 is parallel to said well via one of its generatrices.

It will be noted that these cylinders 441 distributed around the circumference of the ring 402 have the function of stiffening the latter, as explained above in relation to the ribs 120, 220 and the prisms 341 of the ring 302, and that the rings 302, 402 are each obtained for example by molding a plastic based on at least one thermoplastic polymer, in such a way that they have a closed or non-closed structure after the processing of this plastic.

FIG. 8 shows the entire locking device 301 or 401 which comprises, apart from the ring 302 or 402, rubber plugs 360 or 460 that close off the base 343, 443 of each prism or cylinder 341, 441 at each of its lateral edges 303, 403 (only a single lateral edge 303, 403 has been shown in FIG. 8). The set of plugs 360 or 460 is designed to exert, via the ring 302, 402, like the aforementioned flange-pieces 5, a predetermined clamping force on the beads T of the cover P, while protecting the beads T from the lateral edges 303 or 403. Each plug 360 or 460 has an internal part 361 or 461 designed to be forcibly fitted into a base 343 or 443, and an external part 362 or 462 designed to bear on the beads T of the cover P.

It will be noted that each of the locking devices 301, 401 advantageously contains no means for fastening the plugs 360, 460 onto the prisms or cylinders 341, 441, thereby reducing its weight. It will be noted that the weight of the locking device 301, 401 is again minimized when the ring 302 or 402 has a closed structure and thus contains no means for joining the ends of the wrapping together.

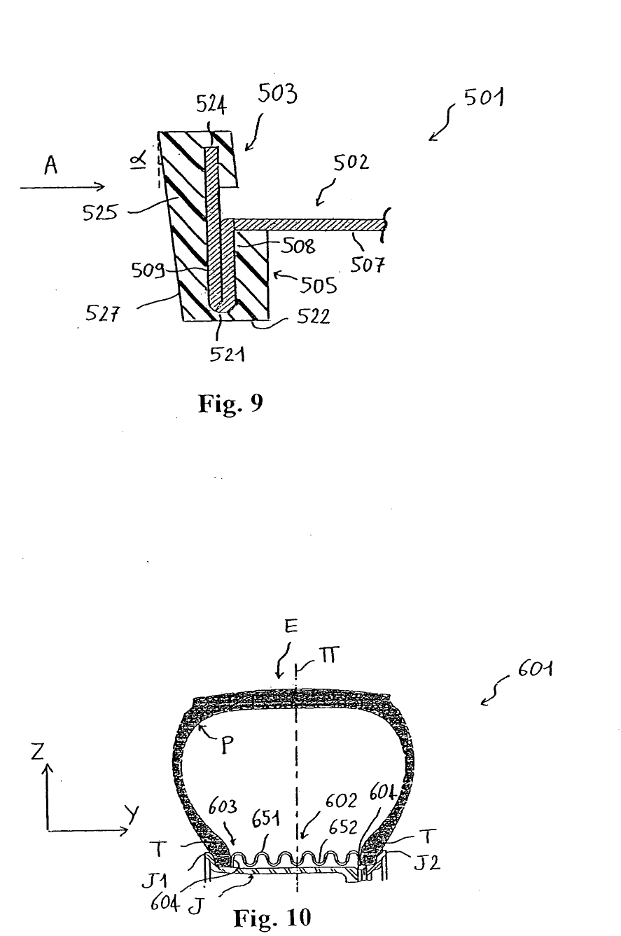

FIG. 9 shows another locking device 501 according to the invention, which comprises a split ring 502, on the lateral edges 503 of which two flange-pieces 505 are mounted respectively (only a single edge 503 and a single flange-piece 505 can be seen in FIG. 9).

Each edge 503 has a cross section forming approximately a “T”, which extends on either side of the central part 507 of the ring 502 lying between said edges 503. More precisely, the central part 507 is extended on one side, approximately at right angles, by a portion 508, which portion is then bent back on itself to form a fold 509 that extends beyond the central part 507, again approximately at right angles to the latter. In addition, the portion 508 and the fold 509 have the same thickness, equal to that of the central part 507, so that the fold 509 has the effect of mechanically reinforcing each lateral edge 503 in anticipation of the stresses depicted by the arrow A.

As may also be seen in FIG. 9, the particular “T” geometry of each lateral edge 503 of the ring 502 is designed to receive the flange-piece 505, the cross section of which is substantially inscribed within a parallelogram and in which a first groove 521 is formed, designed to clamp the portion 508 and the juxtaposed part opposite the fold 509. The external face 522 of the core of this groove 521 is intended to be fitted into the well of the rim J. A second groove 524, designed to grip the free end of the fold 509, is also formed in this flange-piece 505.

A linking part 525 of the flange-piece 505 joining the grooves 521 and 524 together is designed to clamp the top of the “T” formed by this lateral edge 503, and the external face 527 of this linking part 525 is chamfered so as to make an angle α with the circumferential mid-plane of the ring 502 which is matched to the profile of the internal face of each bead T of the cover P, so that this external face 527 follows the shape of this bead T.

It will be noted that the fitting of the pair of split flange-pieces 505 onto the edges 503 of this split ring 502 proves to be robust owing to the specific geometries of the edges 503 and of the flange-pieces 505, thereby dispensing with any means for fastening the flange-pieces 505 to this ring 503 and consequently obtaining a locking device 501 according to the invention that is lighter than those of the prior art, consisting only of the ring 502, the flange-pieces 505 and said joining bars 9 provided with fastening means 10.

FIG. 10 shows, in meridional section, another locking device 601 according to the invention, which is fitted inside a mounted assembly E against the beads T of a cover P, which cover is mounted on a rim J, for example a multi-piece rim. This locking device 601 consists here only of a closed metal ring 602, (for example made of titanium) having circumferential corrugations (i.e. they are parallel to a directrix of the ring 602) consisting of an alternation of ribs 651 and grooves 652, from one lateral edge 603 of the ring 602 to the other. Each lateral edge 603 has a crown-shaped bearing surface 604 that is parallel to the radial direction Z of the fitted assembly E, extending radially upward from its free end 605, and that is intended to bear on a bead T. This bearing surface 604 is extended axially (see the axial direction Y in FIG. 10) in order to form, in alternation, a rib 651 and a groove 652 as far as a final rib 651 that is extended axially by another, identical bearing surface 604, this for example being symmetrical with the previous one relative to the circumferential mid-plane Π of the fitted assembly E (FIG. 10 shows that this plane Π may constitute a plane of symmetry for the ring 602).

It will be noted that these corrugations have the effect of giving the ring 602 sufficient elasticity to allow it to exert the required axial force on the beads T despite the manufacturing tolerances, especially of the cover P. Advantageously, this makes it possible to dispense with any annular linking flange-piece between the ring 602 and the beads T. This results in a significant weight saving for the locking device 601 consisting of this ring 602. It will be noted that the weight of the locking device 601 formed by this ring 602 is again minimized because this ring 602 has a closed structure and thus contains no means for joining the ends of the wrapping together.

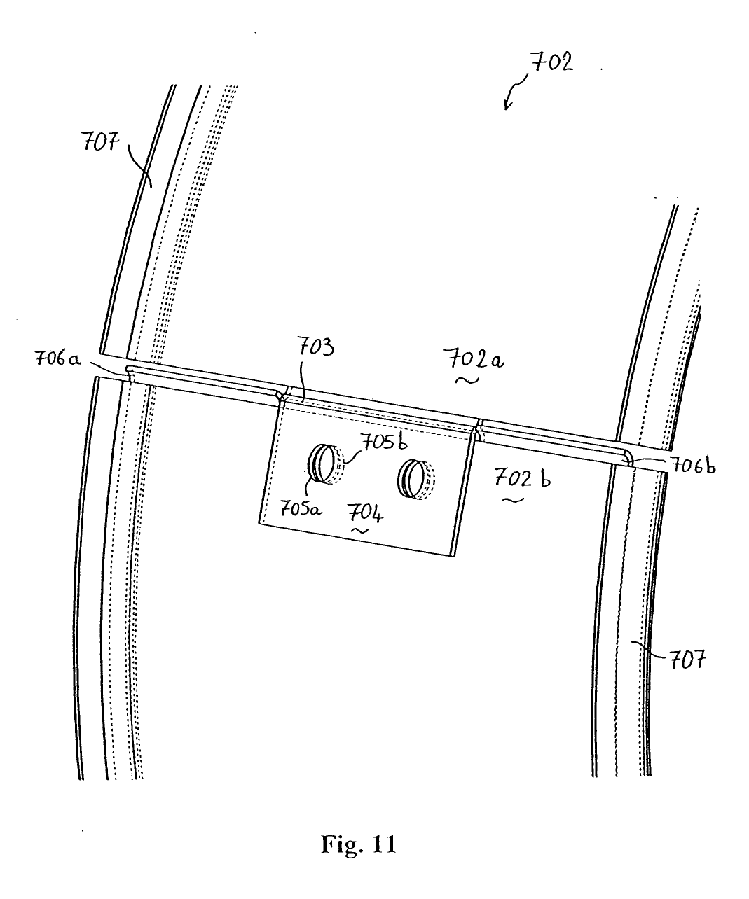

FIG. 11 illustrates an advantageous embodiment of the means for securing the two ends 702a and 702b of a split ring 702 according to the invention. This embodiment differs essentially from the securing mode illustrated in FIG. 3 in that the ring and the securing means used are made as one piece and are not attached to these ends 702a and 702b.

In the exemplary embodiment of FIG. 11, one of the ends 702a is extended in the circumferential direction of the ring 702, over part of its axial width, via a slight radial shoulder 703 by a securing tab 704 that covers the other end 702b, said tab being centered on the circumferential mid-plane of the ring 702. Pairs of facing holes 705a and 705b are formed both in the tab 704 and in the end 702b that it covers, each pair of holes 705a, 705b being designed to receive a bolt (not shown) for mechanically fastening the tab 704 to the end 702b.

In the exemplary embodiment of FIG. 11, this covered end 702b is extended by two projections 706a and 706b radially bent-up toward the outside of the ring 702. These projections 706a and 706b extend axially on either side of the tab 704, to approximately the lateral edges 707 of the ring 702, and are designed to stiffen the ring 702 in its width direction.

It will be noted that this method of securing the ends 702a and 702b of the split ring 702 has the advantage of reducing the number of components attached to this ring 702, while contributing locally to stiffening the closure region of the latter.

In general, it will be noted that the split rings 102, 202 and 502 of FIGS. 4, 5 and 9 are preferably made of metal, these being obtained from a metal sheet based on a high-hardness steel, the hardness of which, measured by means of the Brinell test, is advantageously greater than 70 kg/mm² and is for example around 80 kg/mm².

In this case, each of these rings 102, 202, 502 is obtained from a thin metal sheet, the thickness of which is less than 2 mm and is advantageously between 0.7 mm and 1.5 mm, for example being equal to 1 mm.

According to an alternative embodiment of the invention, these rings 102, 202, 502 may be based on at least one thermoplastic polymer, thereby helping to reduce the weight of the corresponding devices 101, 201, 501.

It will also be noted that the fitting of the locking devices 301, 401, 601 illustrated in FIGS. 6, 7 and 10 inside the fitted assembly E may be carried out in a simplified manner owing to the fact that each of these devices 301, 401, 601 may have a closed annular structure requiring no operation to join the ends of the wrapping together.

It will be noted that each of the locking devices 101 to 601 according to the invention has a weight practically half—around 5 kg—in comparison to the weights, of around 10 kg, that characterize the locking devices 1 of the prior art, especially because of the use according to the invention of a thin metal sheet (typically with a thickness of 1 mm) or of a thermoplastic polymer and, in addition, in the case of the ring 201 shown in FIG. 5, because of the apertured structure that may characterize it.

It follows in particular from this reduced weight of the locking devices 101 to 601 according to the invention and, consequently, of the fitted assemblies E that incorporate them, that the cost of airlifting fleets of vehicles, such as armored military vehicles, equipped with fitted assemblies E each incorporating these locking devices 101 to 601, is substantially minimized.

It will be noted that the locking devices 101 to 601 according to the invention clamp the beads T of the tire cover P satisfactorily, so as to prevent a loss of motricity even with a reduced inflation pressure inside said cover P.

1. Locking device (101, 201, 301, 401, 501, 601) for locking the beads (T) of a tire cover (P) against the flanges (J1, J2) of a wheel rim (J) onto which said cover (P) is fitted, said device comprising an annular structure of less than 10 kg in weight, which is attached around said rim (J), said structure comprising a cylindrical ring (102, 202, 502, 602) and, at least locally, means (120, 220, 341, 441, 509, 609) for stiffening said ring so as to increase its mechanical resistance to compressive forces exerted by the beads (T) against said structure, characterized in that the lateral edges (503, 603) of the ring that extend on either side of its cylindrical surface, in a first case, receive linking means (360, 460, 505) made of an elastic material that are intended to come into contact with the beads (T) of the cover (P) or, in a second case, have bearing surfaces (604) designed to bear on said beads (T) via elastic means in the form of circumference corrugations in said ring.

2. Locking device (101, 201, 301, 401, 501, 601) according to claim 1, characterized in that said structure has a weight of 7 kg or less.

3. Locking device (101, 201, 501) according to claim 1, characterized in that, in said first case, said ring (102, 202, 502) is split and has a thickness of material of 8 mm or less.

4. Locking device (501) according to claim 3, characterized in that each lateral edge (503) of the ring (502) has a cross section in the form of a “T”.

5. Locking device (501) according to claim 4, characterized in that said ring (502) includes a central part (507) between said lateral edges (503) that is extended approximately at right angles by a portion (508) that is folded back on itself to form a fold (509) constituting the top of said “T”.

6. Locking device (501) according to claim 3, characterized in that said linking means comprise two annular rubber flange-pieces (505) that are mounted on said lateral edges (503) respectively.

7. Locking device (501) according to claim 6, characterized in that it contains no means for fastening said flange-pieces (505) to said ring (502).

8. Locking device (101, 201, 301, 401) according to claim 1, characterized in that, in said first case, said ring (102, 202, 302, 402) includes a plurality of ribs (120, 220, 341, 441) formed along generatrices of the ring (102, 202, 302, 402) said ribs (120, 220, 341, 441) being designed to stiffen said device (101, 201, 301, 401) with regard to forces exerted thereon in its width direction.

9. Locking device (201) according to claim 8, characterized in that said ring (202) is apertured between said lateral edges (203).

10. Locking device according to claim 1, characterized in that, in said first case, said ring includes, over its circumference and between said lateral edges, a plurality of openings, the wall of at least one or of each of said openings forming a rib on at least one face of said ring.

11. Locking device (101, 201, 501) according to claim 3, characterized in that said ring (102, 202, 502) is based on a metal sheet or on at least one thermoplastic polymer.

12. Locking device (301, 401) according to claim 8, characterized in that each of said ribs (341, 441) has a prismatic or cylindrical geometry, linking means (360, 460) designed to come into contact with the beads (T) of the cover (P) including a plurality of plugs (360, 460) that respectively close off the hollow bases (343, 443) of at least several of said ribs (341, 441).

13. Locking device (301, 401) according to claim 12, characterized in that it contains no means for fastening said plugs (360, 460) to said ring (302, 402).

14. Locking device (301, 401) according to claim 12, characterized in that said ring (302, 402) is based on at least one thermoplastic polymer.

15. Locking device according to claim 1, characterized in that, in said first case, the ring comprises, along its generatrices, a plurality of cylindrical or prismatic tubes that are connected together pairwise via at least one joining element and are designed to stiffen said device with regard to forces exerted thereon in its width direction.

16. Locking device (601) according to claim 1, characterized in that, in said second case, said ring (602) is closed.

17. Locking device (601) according to claim 16, characterized in that, in said second case, said bearing surface (604) of each of said lateral edges (603) has a crown shape.

18. Locking device (601) according to claim 17, characterized in that it consists of said ring (602).

19. Locking device according to claim 1, characterized in that said ring is split (702), at least one of its two ends (702a) terminating in at least one tab (704) intended to secure said ends (702a and 702b) one with respect to the other.

20. Locking device according to claim 19, characterized in that the width of said or each securing tab (704) is less than that of said ring (702), the other or each end (702b) terminating in at least one bent-up radial projection (706a, 706b) that is designed to stiffen said ring in its width direction.

21. Locking device according to claim 20, characterized in that one of said ends (702a) terminates in said securing tab (704) and in that the other end (702b) terminates in a pair of said projections (706a, 706b) that are bent up radially toward the outside on either side of said tab, or else by a single projection bent up radially inward over the width of said tab, which projection is designed to be fastened to said other end that it covers by mechanical fastening or by adhesive bonding.

22. Fitted assembly (E) that can be used to equip a motorized vehicle designed to be driven over loose or rough ground and/or with reduced inflation pressures, such as an armored military vehicle or a civil vehicle of the “off-road” type, said fitted assembly (E) comprising a wheel rim (J), which terminates axially on the outside in two flanges (J1, J2), and a tire cover (P) having beads (T) mounted against said flanges (J1, J2), respectively, via a locking device designed to jam said beads (T) against said flanges (J1, J2), characterized in that said locking device (101, 201, 301, 401, 501, 601) is as defined in claim 1.

23. Motorized vehicle that can be used for being driven on loose or rough ground and/or with reduced inflation pressures, such as an armored military vehicle or a civil vehicle of the “off-road” type, characterized in that it is provided with fitted assemblies (E) according to claim 22.
